(19) United States
(12) Patent Application Publication
(10) Pub. No.: US 2007/0137073 A1
(43) Pub. Date: Jun. 21, 2007

(54) REPLY GREETING CARDS

(76) Inventor: Marilu Vinocur, Louisville, KY (US)

Correspondence Address: Marilu Vinocur, 8321 Stillmeadow Drive, Louisville, KY, 40299, US

(21) Appl. No.: 11/306,050

(22) Filed: Dec. 15, 2005

(51) Int. Cl. G09F 1/00

(52) U.S. Cl. 40/124.11

(57) ABSTRACT

Greeting cards intended as a reply to other greeting cards, or as a reply to expressed emotions. The reply greeting cards may be paper, electronic, or other delivery medium and may be written in any language or languages. The reply greeting cards may the same basic design of a new or an existing greeting card.

### BACKGROUND OF THE INVENTION

Greeting cards are a wonderful way to express your feelings to others without having to worry about what to say. Greeting cards can be humorous or serious and can be for almost any occasion. Whether it's a birthday, a wedding, a holiday, a life cycle event, love, friendship, sympathy, or just to say “hi”, there are warm, heart-felt greeting cards available. Except, greeting cards in reply to other greeting cards.

### BRIEF SUMMARY OF THE INVENTION

This invention allows people to express themselves, by replying to other greeting cards or replying to expressed emotions. When someone feels touched by a greeting card that they received, when they feel cared for, appreciated, motivated, pleased, honored, needed, loved, important, missed, they can express themselves by sending a reply greeting card. Out of gratitude, kindness, love, respect, happiness, or just because, there can now be reply greeting cards for almost any occasion.

### BRIEF DESCRIPTION OF THE DRAWINGS

FIG. 1 shows a sample of a Reply Greeting Card while FIG. 2 shows a Greeting Card that it's replying to.

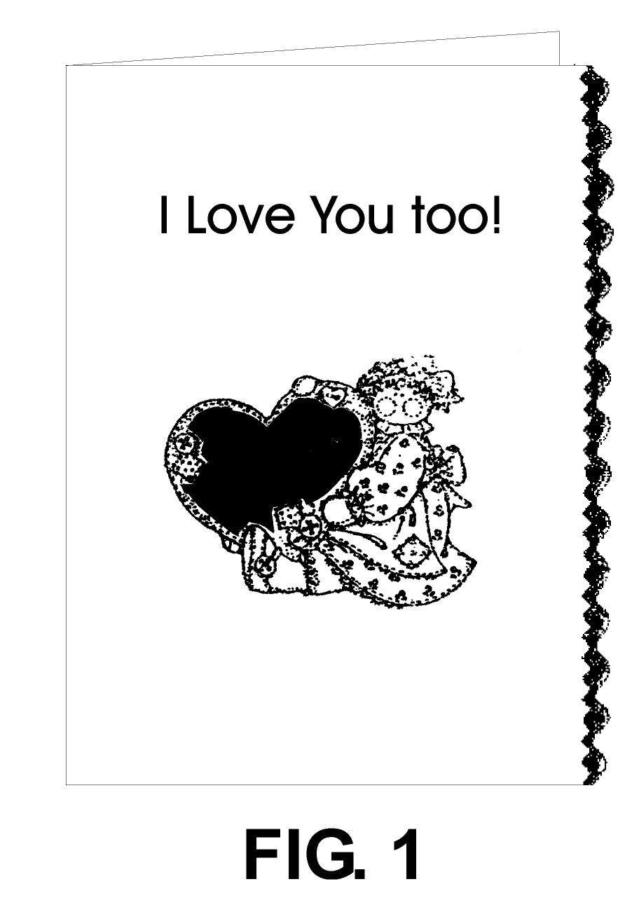

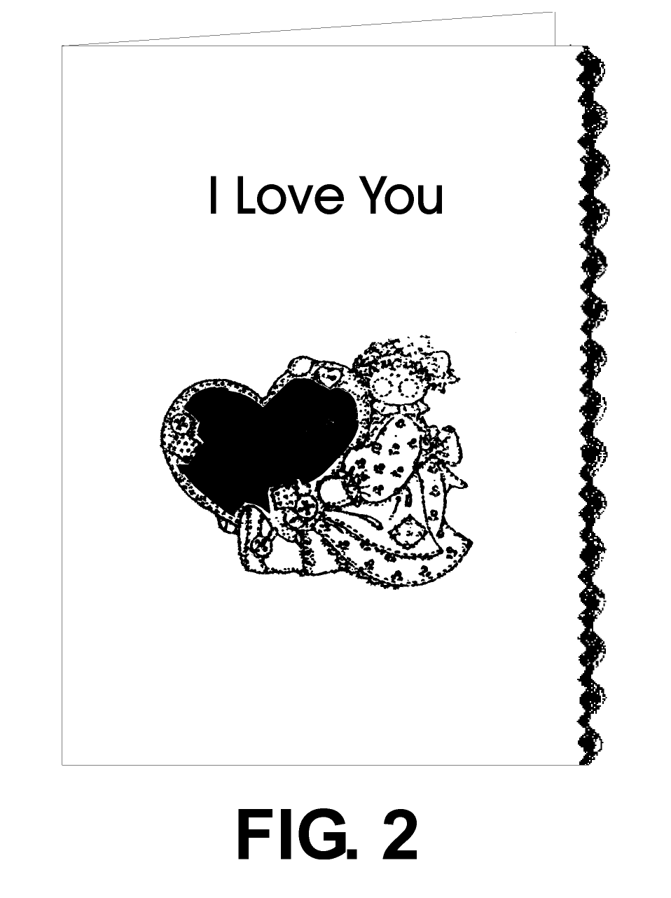

### DETAILED DESCRIPTION OF THE INVENTION

In one embodiment, the Reply Greeting Cards are intended as a reply to other Greeting Cards. In a second embodiment, the Reply Greeting Cards are intended as a reply to expressed emotions either verbal or written. Below is a table showing some examples of Reply Greeting Cards and what they are replying to.

| Reply Greeting Card | Replying to: |
|---|---|
| You're welcome | Thank you |
| You're very welcome | |
| Don't mention it | |
| It was nothing | |
| Oh, please! It's the least I can do | |
| I did it, from the bottom of my heart | |
| Any time | |
| You're welcome I really enjoyed it | |
| You deserve it | |
| The pleasure was mine | Thanks for your |
| The honor was mine | hospitality |
| Our house, is your house | |
| Our house, will always be your house | |
| You're always welcomed | |
| May your holidays be just as happy | Happy holidays |
| Likewise | |
| You too | |
| The same to you | |
| We will | |
| I miss you too | Missing you |
| I'll miss you too | |
| Miss you too | |
| Missing you too | |
| We'll miss you too | |
| So am I | |
| I know you will (comical) | |
| I know | Thinking of you |
| Me too | |
| I'm thinking about me too (comical) | |
| Your condolences are appreciated | Sympathy |
| I'm doing much better now | |
| I love you too | I love you |
| Love you too | |
| I know you love me | |
| We love you too | |
| It's mutual | |
| So do I | |
| Me too, “I love me too” (comical) | |
| I love you three (comical) | |
| I need you too | I need you |
| Need you too | |
| Not a problem | I'm sorry |
| Don't worry | |
| It's OK | |
| That's OK | |
| Your apologies have been accepted | |
| You're forgiven | |
| No, You're not (comical) | |

What is claimed is:

1. Greeting Cards intended as a reply to other Greeting Cards, or as a reply to expressed emotions.

2. Reply Greeting Cards of claim 1 in paper, electronic, or other delivery medium.

3. Reply Greeting Cards of claim 1 written in any language or languages.

4. Reply Greeting Cards of claim 1 with a message stating what it is in reply to.

5. Reply Greeting Cards of claim 1 based on any example or examples in this patent.

6. Reply Greeting Cards of claim 1 with the same basic design of new or existing Greeting Cards.
